(19) United States
(12) Patent Application Publication
(10) Pub. No.: US 2007/0062777 A1
(43) Pub. Date: Mar. 22, 2007

(54) FRICTION PLATES AND REACTION PLATES FOR FRICTION CLUTCHES AND BRAKES WITH REDUCED THERMAL STRESSES

(76) Inventors: Przemyslaw Zagrodzki, West Lafayette, IN (US); Christopher W. Horbach, Crawfordsville, IN (US)

Correspondence Address: BOSE MCKINNEY & EVANS LLP;JAMES COLES, 135 N PENNSYLVANIA ST, SUITE 2700, INDIANAPOLIS, IN, 46204, US

(21) Appl. No.: 11/533,852

(22) Filed: Sep. 21, 2006

Related U.S. Application Data
(60) Provisional application No. 60/719,366, filed on Sep. 22, 2005.

(51) Int. Cl. F16D 13/64

(52) U.S. Cl. 192/70.2

(57) ABSTRACT

A torque transfer apparatus including a torque transfer plate with reduced thermal stresses. The apparatus includes a housing and a pack including at least one pair of plates interacting to transfer torque. At least one of the plates includes a plurality of teeth with at least two slots to reduce thermal stresses.

### CROSS-REFERENCE TO RELATED APPLICATION

This application claims the benefit of U.S. Provisional Patent Application Ser. No. 60/719,366, filed Sep. 22, 2005, titled “Friction Plates and Reaction Plates for Friction Clutches and Brakes with Reduced Thermal Stresses”, the disclosure of which is expressly incorporated by reference herein in its entirety.

### BACKGROUND OF THE INVENTION

Torque transfer apparatuses are useful in a wide variety of applications including, for example, clutches and friction brakes for passenger vehicles, commercial vehicles and equipment, industrial vehicles and equipment, agricultural vehicles and equipment, and others. These torque transfer apparatuses and others include at least one or more pairs of surfaces which interact to transfer torque. Typically such apparatuses include plates or disks which may be arranged, for example, in a friction pack. Applying force to the plate(s) or disk(s) can generate frictional torque resulting in torque transfer.

### SUMMARY OF THE INVENTION

In one embodiment of the present invention there is provided a torque transfer member including a plate having an annular portion with a plurality of splines. Each of the plurality of splines includes a bottom portion. The annular portion is disposed at one of an inner or an outer perimeter of the plate. The plate defines a non-friction area and a friction area located adjacent the non-friction area and defines therebetween a boundary. The bottom portion of each of the plurality of splines extends substantially to the boundary.

In another embodiment of the present invention, there is provided a torque transfer member including a plate having an annular portion with a plurality of splines. Each of the plurality of splines includes a bottom portion having a slot. The plate defines a non-friction area and a friction area located adjacent the non-friction area and defines therebetween a boundary. The slot of the bottom portion of each of the plurality of splines extends to the boundary.

In still another embodiment of the present invention there is provided a torque transfer apparatus including a housing, a hub, at least partially disposed within the housing, and a first plate, coupled to one of the housing and the hub. The first plate includes a friction material and an annular portion having a plurality of splines. The annular portion is disposed at one of an inner or an outer perimeter of the plate. A second plate is coupled to the other of the housing and the hub and is located adjacent to the first plate. The second plate includes an annular portion having a plurality of splines wherein the annular portion is disposed at one of an inner and an outer perimeter of the plate and wherein each of the plurality of splines includes a bottom portion. The second plate defines a boundary between a non-friction area and a friction area corresponding to the location of the friction material of the first plate wherein the bottom portion of each of the plurality of splines of the second plate is located substantially at the boundary.

In accordance with one aspect of the present invention there is provided, a torque transfer member including a plate having a plurality of splines wherein each of the plurality of splines is located at one of an inner and an outer annular portion. The plate further includes a plurality of slots, the slots being located at the other of the inner and the outer annular portion. The plate defines a non-friction area and a friction area located adjacent the non-friction area and defines therebetween a boundary, wherein each of the slots extends substantially to the boundary.

Pursuant to another aspect of the present invention there is provided a method of making a torque transfer plate for use in a torque transfer apparatus including a first plate and a second plate, wherein the second plate includes a friction material having a predefined area defining a friction area on the first plate. The method comprises the steps of determining the location of the friction area on the first plate and a non-friction area on the first plate relative to the friction area of the first plate, determining a boundary on the first plate based on the determined location of the friction area and the non-friction area of the first plate, and making the torque transfer plate to include a plurality of splines, each of the plurality of splines including a bottom portion, wherein the bottom portion of each of the plurality of splines is made in the non-friction area to extend to the boundary.

### BRIEF DESCRIPTION OF THE DRAWINGS

FIG. 1 illustrates a schematic cross-sectional view of a portion of a torque transfer apparatus of the present invention.

FIG. 2 illustrates an axial cross-sectional fragmentary view of a single-sided clutch pack of the present invention.

FIG. 3 illustrates an axial cross-sectional fragmentary view of a double-side clutch pack of the present invention.

FIGS. 4A and 4B illustrate a plan view of a plate including external splines of the prior art.

FIG. 4C illustrates a partial plan view of a plate including external splines of the prior art including a receiving portion of a housing.

FIGS. 5A and 5B illustrate a partial plan view of one embodiment of a plate of the present invention including spline geometry.

FIG. 5C illustrate a plan view of one embodiment of a plate of the present invention including spline geometry and a receiving portion of a housing.

FIGS. 6A and 6B illustrate a plan view of one embodiment of a plate of the present invention including spline geometry wherein adjacent bottom portions include different radii.

FIGS. 7A and 7B illustrate a plan view of one embodiment of a plate of the present invention including spline geometry wherein bottom portions include a slot.

FIGS. 8A and 8B illustrate a plan view of one embodiment of a plate of the present invention including spline geometry wherein bottom portions include a slot not aligned along the radius.

FIGS. 9A and 9B illustrate a plan view of one embodiment of a plate of the present invention including spline geometry wherein bottom portions include a slot having non-parallel sides.

FIGS. 10A and 10B illustrate a plan view of one embodiment of a plate of the present invention including spline geometry wherein bottom portions include a slot having an arc.

FIGS. 11A and 11B illustrate a plan view of one embodiment of a plate of the present invention including spline geometry wherein bottom portions include a slot located at every other space.

FIGS. 12A and 12B illustrate a plan view of a prior art plate having inner splines.

FIGS. 13A and 13B illustrate a plan view of a plate of the present invention including inner splines wherein bottom portions include a slot.

FIGS. 14A and 14B illustrate a plan view of a plate including slots in a portion thereof opposite a portion having splines.

### DETAILED DESCRIPTION OF THE DRAWINGS AND THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

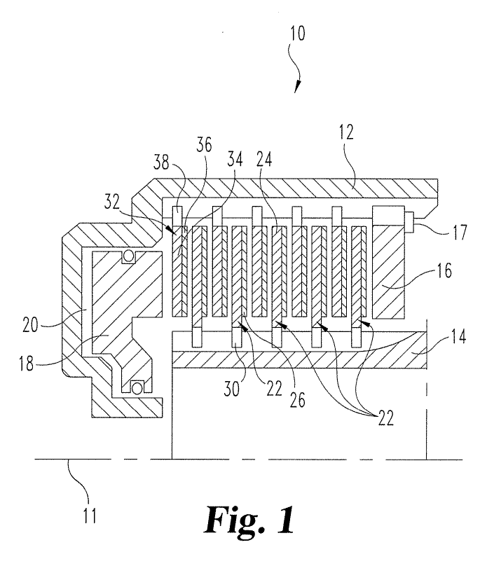

FIG. 1 is a schematic cross-sectional view of a portion of a torque transfer apparatus such as a friction clutch including a set of friction plates of the present invention. While a friction clutch is illustrated in FIG. 1, the various aspects of the described clutch are equally applicable to friction brakes. Consequently, the described embodiments include torque transfer apparatuses or devices including friction clutches and friction brakes. In addition, FIG. 1 illustrates a schematic view of the friction clutch 10 illustrated along a center axis 11 around which the clutch 10 is symmetrical such that the remaining portions of the clutch are not illustrated.

The friction clutch 10 includes a clutch retainer 12, which is also known as a drum or housing, to enclose the internal components of the friction clutch 10. Disposed within the clutch retainer 12 is a hub 14, or shaft, which holds a plurality of friction plates. An end plate 16, also known as a backing plate or pressure plate, is coupled to an interior portion of the clutch retainer 12. A snap ring 17 is coupled to the housing 12 to position and to hold the end plate 16 as illustrated. At an opposite end of the clutch retainer 12, a piston 18 is disposed within a piston chamber 20 defined by an interior portion of the clutch retainer 12. The housing 12, hub 14, end plate 16, piston 18, and piston chamber 20 are common components of friction clutches and are known by those skilled in the art. Additional members or parts are not illustrated to facilitate the present description.

Coupled to the hub 14, as stated above, is a plurality of single sided friction plates 22 each of which includes a metal core 24 and a friction lining 26 attached thereto. The metal core 24 includes a plurality of splines 30 which engage the hub 14 for holding the friction plates 22 in fixed angular (or rotational) positions while permitting axial movement with respect to the hub 14. Friction plates 22 are disposed along the hub 14 and the plurality of splines or teeth 30 are received by corresponding spaces formed in the hub 14. The configuration of the splines is described in more detail in the remaining figures.

A second plurality of friction plates 32 each of which includes a metal core 34 and a friction lining 36, are disposed along and coupled to an inner portion of the housing 12. Each of the metal cores 34 include a plurality of splines 38 to couple the friction plates 32 for rotation to the housing 12 while permitting axial movement. The first plurality of friction plates 22 are not in contact with respect to the second plurality of friction plates 32 when the clutch is not engaged. However, upon engagement of the clutch, the first plurality of friction plates 22 and second plurality of friction plates 32 are forced under pressure into frictional contact so that torque can be transferred from the housing 12 to the hub 14 (or vice versa).

The torque transfer apparatus of FIG. 1 illustrates a plurality of single sided friction plates, each of which includes a metal core and a friction lining. Torque transfer apparatuses can also include bare metal reaction plates collaborating with double sided friction plates, including a metal core and a friction lining on both sides of the core.

Friction clutches or brakes comprise a set of circular shaped plates. Each plate can include connecting features, the most common of which are splines, for connecting the plates for rotation to the housing or hub. Such connecting features include for instance splines, teeth, keys, tabs or eyelets. The connecting feature has either a regular or an irregular distribution around a perimeter or circumference, located either about or within a plate. The irregular distribution means that the shape, the width and the spacing of the projections constituting the connecting feature may vary around the circumference. While the present invention is directed to plates including connecting features, the present description will generally use the terms spline(s) and teeth for ease of understanding the described embodiments. Consequently, spline(s) as used herein include all connecting features. The use of such terms is not intended to limit the scope of the present invention. Consequently, the present invention includes plates having connecting features such as splines, teeth, keys, tabs, eyelets or other connecting features known to those skilled in the art.

As previously illustrated in FIG. 1, the first plurality of friction plates 22 include internal splines and the second plurality of friction plates 32 include external splines. The plates with the internal splines are alternately arranged with those having the external splines so that each of the adjacent plates create an interface between a surface of a plate connected to the shaft 14 and a surface of the plate connected to housing 12. The two surfaces constituting the interface are most typically made of dissimilar materials. For instance, the friction lining 36 of friction plate 32 contacts the metal core 24 of the friction plate 22. Common materials used in friction clutches and brakes can include ferrous metal (steel or cast iron) mated to a composite friction material, although other combinations of materials can also be used. A variety of friction materials are used in friction clutches and brakes, for example paper-based composites, carbon composites, elastomeric materials, and sintered metals. Common materials for wet clutches and brakes are wet laid fiber paper materials. The porous paper is composed of fibers, fillers and friction particles used for both structural and friction purposes. A thermally stable resin binder is then used to impregnate the paper to provide strength and additional friction performance characteristics.

Different arrangements of the plates 22 and plates 32 are possible. Such arrangements are known as packs and can include clutch packs and brake packs. Single sided clutch packs and double sided clutch packs are common.

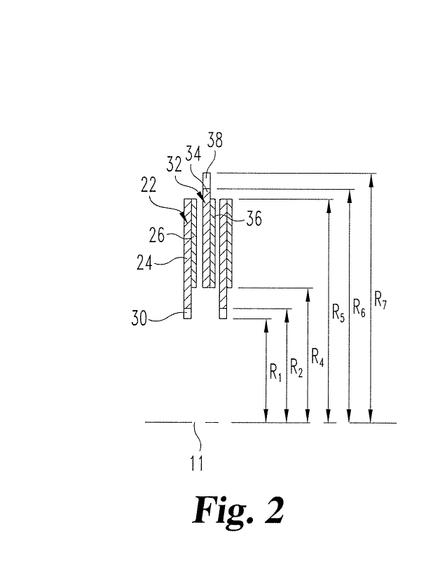

As illustrated in FIG. 2, an axial cross section fragmentary view of the single sided clutch pack of FIG. 1 is shown. Three plates are illustrated. As previously described, the single sided pack includes plates, or disks, each of which has a steel core 24 or 34 and a layer of friction material 26 or 36 bonded to the metal core. Consequently, each of the clutch plates has an exposed metal surface on a first side and a friction material surface on a second side. The friction disks 22 include internal splines 30 and the friction plates 32 include external splines 34. The clutch plates 22 and clutch plates 32 are alternately arranged such that the friction material surface faces a metal surface of an adjacent disk.

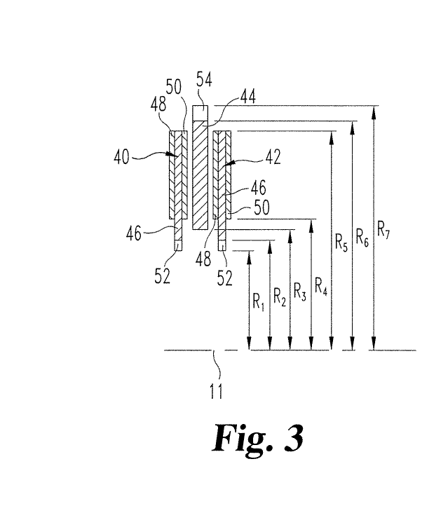

FIG. 3 illustrates a further example of a clutch pack including double-sided plates. The fragmentary view of FIG. 3 illustrates a first friction plate 40 and a second friction plate 42, each of which are coupled to the hub 14 (not shown). Disposed between the first friction plate 40 and the second friction plate 42 is a reaction plate 44 which is coupled to the housing 12 (not shown). Each of the first and second friction plates 40 and 42 include a metal core or metal plate 46 to which a first friction material 48 and a second friction material 50 are permanently attached, most typically by bonding. During operation of the clutch pack of FIG. 3, the friction material 50 or the friction material 48 can contact a first surface or a second opposed surface of the reaction plate 44. As previously described, each of the first and second friction plates 40 and 42 include a plurality of splines 52 coupled to the hub 14 and the reaction plates 44 include a plurality of splines 54 coupled to the housing 12.

Another arrangement of a pack with double sided plates is also known: the friction plates have external spline and are connected to the drum while reaction plates have internal spline and are connected to the hub.

The single sided pack of FIG. 2 and the double sided pack of FIG. 3 are each illustrated to include the longitudinal axis 11 illustrated in FIG. 1. The longitudinal axis 11 defines an axial cross-section of the entire clutch mechanism of FIG. 1 but illustrating a portion of the clutch pack. The longitudinal axis 11 of FIG. 2 and 3 will be used as a reference line for defining the construction of the plates.

Although the clutch shown in FIG. 1. has a pack of single sided plates, a pack of double sided plates can be used in this clutch as well. When the torque transfer apparatus is disengaged, the surfaces of adjacent plates are separated so that no frictional torque is transmitted by any pair of adjacent plates. The shaft 14 and the drum 12 can rotate independently at different speeds or one of the shaft or drum can rotate while the other remains motionless. The clutch 10 which is equipped with an actuator, most typically of a hydraulic type including piston 18, exerts axial forces on the disk for engagement. Other types of actuators, e.g. electromechanical, are also used. The axial force brings the disks or plates 22 into engagement with the disk or plates 32 which results in the generation of friction forces at the interfaces therebetween. A torque resulting from the friction forces found at the interface tends to reduce the initial speed difference between the shaft 14 and the drum 12. Depending on the torque transfer device application, the frictional engagement between adjacent friction plates can result in a speed synchronization between the shaft and drum whereby adjacent plates rotate at substantially the same speed, as is the case with clutches, or in bringing the rotating part in still stand in the case of brakes; alternatively, the frictional engagement in slipping clutches or in brakes used for retarding can consist of a long-slip operation, as is known by those skilled in the art. In any case, a substantial amount of energy in the form heat can be generated due to the appearance of friction at the interfaces where the plates can slide with respect to one another when in contact. Frictional heat causes a temperature rise in the components of the pack which in turn and in combination with a thermal expansion produces thermal stresses.

Thermal stresses in metal components reach much higher values than those in friction material; this is because the stress is generally proportional to the modulus of elasticity of material and the modulus of ferrous materials is several orders of magnitude higher than that of typical friction material. Therefore, the problems related to thermal stress occur substantially in the metal components of the pack. The metal components subjected to high thermal stresses include cores in the single sided plates, both those with internal and those with external splines, and reaction plates in the double sided packs. Unlike these components, the metal cores in double sided packs are subjected to lower thermal stresses since they are not directly exposed to frictional heating. The layers of friction material on both sides of such a plate, which material is most typically a poor thermal conductor, shield the core from frictional heat. Therefore, the following description of the problems related to thermal stresses and, consequently, the embodiments of the current invention aimed at reduction of thermal stresses apply substantially to the following parts of the clutch pack: single sided plates, both internally and externally splined, reaction plates in the double sided pack, end plates and apply plates in either single sided or double sided packs wherever they create a sliding interface with an adjacent friction plate.

Thermal stresses are known to be one of the major causes of failures of plates in clutches and brakes that can lead to a failure or a malfunction of the entire clutch or brake. More specifically, if the stress exceeds a material yield limit, which can occur in practical applications, a residual stress is produced and remains in the plates after the plates cool down and return to room temperature. Residual stresses can often be so high that permanent deformation of the plates can occur. Common forms of permanent deformations include coning, where originally flat surfaces of the plate become conical, and warping. It is known from industrial practices that these deformations can reach such a large magnitude that clutch or brake failure results. Another known failure mode of the plates is cracking. High residual stress often leads to cracks originating from the disk surface and penetrating some depth; fractures across the entire plate thickness have also been observed in service.

In the thermal stresses in annual plates or disks, one of the critical components is the hoop stress (circumferential stress component). The hoop stress is driven by temperature variation in radial direction, and it often reaches highest values among all stress components. Hoop stress can effectively be reduced by implementing slots or notches in the disks which disrupt disk's continuity in circumferential direction. Slots are known in the prior art as shown in U.S. Pat. Nos. 2,835,355; 2,905,279; 5,850,895, and 5,975,267. Unlike in the current invention, the slots according to prior art are located in the areas of the plates which intimately interact with the friction material on the mating surface, which material is generally relatively soft and susceptible to mechanical damage. It was determined that the slots according to prior art contribute to accelerated wear and in extreme cases to damage of friction material. As it will be apparent from the following description, the slots according to current invention are substantially located in the areas of plates that do not contact friction material on the mating surface and therefore do not contribute to wear. Also, while the prior art slots reduce thermal stress induced by temperature variation across the entire radial width of friction disks, current invention provides reduction of stress caused by temperature difference between friction area and non-friction area as defined and explained in the following description.

Each of the friction plates 22, 32 in FIG. 2, friction plates 40 and the reaction plate 44 in FIG. 3, are substantially circular or disk shaped. Sliding interfaces are created by pairs of adjacent surfaces: surface of friction material on one of the plates and bare metal surface on the adjacent plate. More specifically, in the single sided pack of FIG. 2 the sliding interface is created by exposed surface of friction material on one single sided plate and the bare metal surface of the core of adjacent single sided plate; in the double sided pack of FIG. 3, the sliding interface is created by the friction material surface on one side of the double sided plate and the metal surface of the adjacent reaction plate. The frictional contact occurs substantially across an annular portion defined by inner radius of friction material R4 and outer radius of friction material R5. This annulus defines friction area. Radial width of metal surfaces creating sliding interface is often greater than that of friction material itself. For instance, the steel core 34 of externally splined single sided friction plate 32 in FIG. 2 extends radially beyond the outer radius of friction area: it has an outstanding annular portion included between radii R5 and R6 and a spline portion included between radii R6 and R7. Similarly, the reaction plate of FIG. 3 has an outstanding annular portion extending inwardly and defined by radii R3 and R4, an outstanding annular portion extending outwardly defined by radii R5 and R6, and spline portion defined by R6 and R7. The outstanding portions of annular surfaces of either reaction plate or metal core of single-sided plate are non-friction areas. Frictional heat is generated on those portions of the surfaces of the metal core 34 or the reaction plate 44 that contact the layers of friction material of the adjacent disks, that means across friction area bounded by the radii R4 and R5 in each of the respective plates in FIG. 2 and FIG. 3. The areas outside the friction area are not subjected to frictional heating. Consequently, portions of steel within the friction area, exposed to frictional heating, experience much higher temperature rise than the portions in non-friction area that are not directly exposed to frictional heating. As a result, significant temperature differences occur between those portions. The temperature gradients contribute to thermal stresses. The stresses arise both in the portions within friction area and in an outstanding part of either the metal core 34 of FIG. 2 or the reaction plate 44 of FIG. 3.

It has been found that the portions defined by radii of R4 and R5 of the reaction plate that experience frictional heating tend to expand thermally in all directions including the radial direction, while the portions that are outside the frictional area remain relatively cool and therefore do not expand to that extent. These differences in thermal expansion between the two portions produce a high thermal stress. It has also been found that an intense frictional heating creates a particularly high circumferential stress, also known as hoop stress, in those outstanding metal portions of the plates. These stresses, which can appear during operation of torque transfer devices, can exceed the yield limit of the steel used for cores of the friction plates and reaction plates and can be a precursor to permanent deformations of the plates. The present invention can reduce the circumferential (hoop) thermal stresses in portions of plates which extend radially beyond the friction area by modifying the geometry of the relative plates.

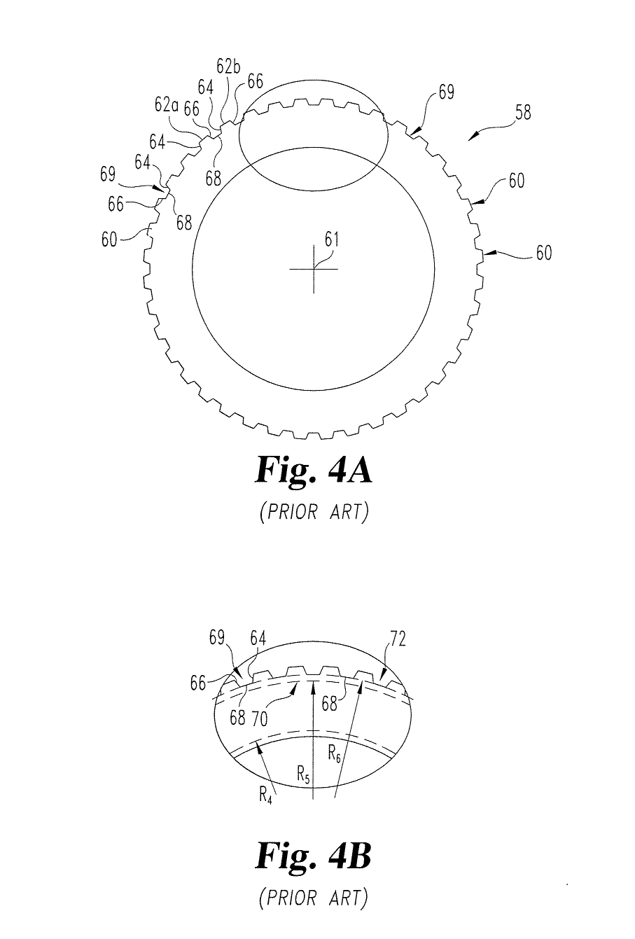

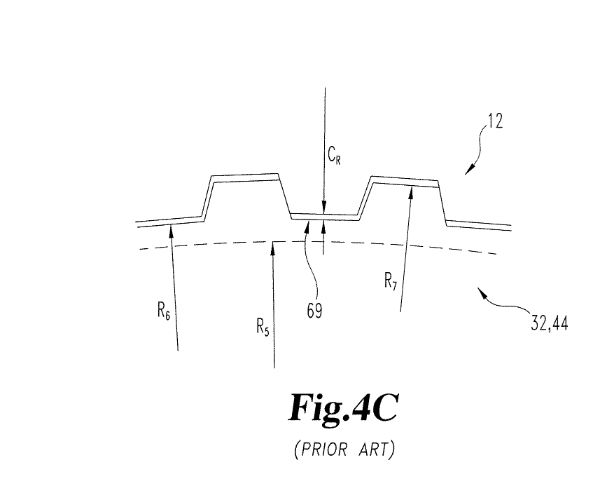

FIGS. 4A and 4B illustrate a reaction plate (or a core of single sided plate) including external splines of the prior art. FIG. 4B illustrates a more detailed portion of FIG. 4A outlined by an oval. Later figures use the same convention. The prior art reaction plate includes a plurality of splines or teeth 60 arranged in a circumferential pattern about a reference center 61. Each of these splines or teeth 60 includes a top portion 62, a first side 64, and a second side 66. Adjacent splines such as spline 62a and 62b have sides 64 and 66 coupled together with a bottom portion 68. Opposed sides 66 and 64 which are coupled to a shared bottom portion or bottom 68 define a space 69.

As illustrated in FIG. 4B, the radius R5 extends to a location 70 defined by a circumference which indicates the outer diameter of the friction area of the prior art friction plate or reaction plate. The radius R6 extends to a circumference 72 which defines a circumferential area located at the bottom portion 68 of the spline geometry. In other words, radius R6 is a half of the minor diameter of the spline. In this prior art configuration, the bottom portion 68 defined by the outer radius R6 is typically close to the inner surface of the drum or housing 12, with an appropriate radial clearance between them necessary to accommodate manufacturing variations and allow for thermal expansion.

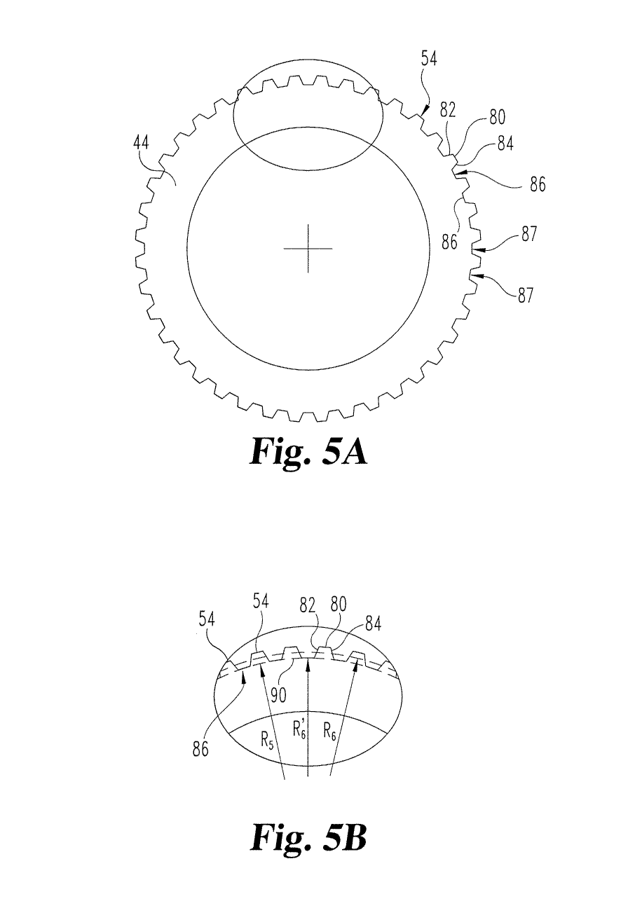

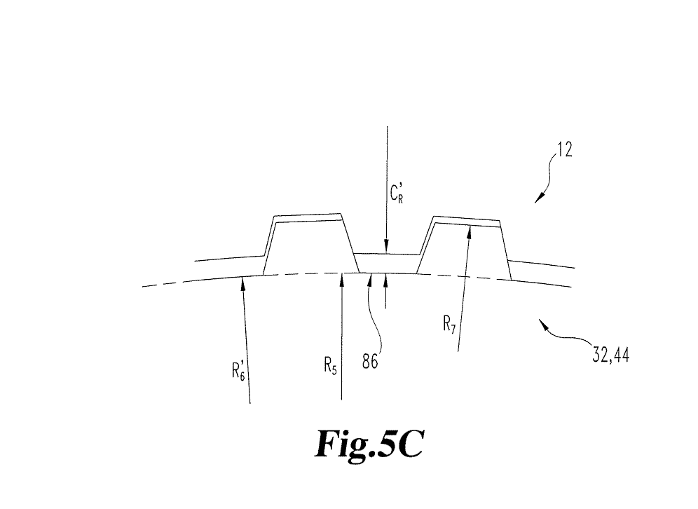

FIGS. 5A and B illustrate one embodiment of the present invention wherein the spline geometry is constructed such that the minor diameter of the spline is reduced so that the radius of the bottom portion of the spline R6′ is substantially the same as the outer radius of the friction surface R5. While the radius R6′ is substantially located at a corresponding edge of the friction material of an adjacent plate, some differences from this edge and R5 is possible. In the case of double sided pack design, it is preferred that this difference should not exceed approximately 2 millimeters or the thickness of the metal reaction plate, whichever is greater; in the case of single sided pack design it is preferred that this difference should not exceed approximately 2 millimeters or the thickness of metal core of single sided plate, whichever is greater. In the reaction plate or the metal core of single sided plate of FIG. 5B, each of the splines 54 includes a top portion 80 a first side 82 and a second side 84. Sides 82 and 84 of adjacent splines 54 are coupled together by a bottom portion 86 which in FIG. 5A and 5B is substantially located at the radius R5. Transition from the bottom portion 86 to sides 82 and 84 can include a fillet or a chamfer.

Opposed sides 82 and 84 which are coupled to a shared bottom portion define space 87. The configuration of the splines of the present invention, because they lie in the portions of material outside the friction area, provides relief primarily to the stresses found in that area of the friction plates or reaction plates. While known slots extend into the friction area, the modified splines of this embodiment of the present invention extend substantially no further than the friction area and thereby prevent friction material on the mating plate from being damaged by exposure to contact with edges of slots or spline teeth.

As explained in the forgoing description, the portions of the metal component located outside the friction area are not directly subjected to frictional heating and therefore do not expand thermally in unison with the portion defined by the frictional area. As the portion defined by the frictional area, which constitutes the major part of the plate, thermally expands, other portions are forced to expand and as a consequence they experience high strain and stress. The stress in these portions may exceed yield limit and could cause a permanent distortion of the plate. The function of the modified splines illustrated in FIG. 5, as well as slots in the embodiments described below, which are in each case placed in the non-friction area, is to provide relief to stresses in these portions. At the same time some stress relief occurs in the heated or friction areas. In most cases, the stress relief in the non-heated portions or the non-friction areas resulting from the current invention is more significant than that found in the heated portions.

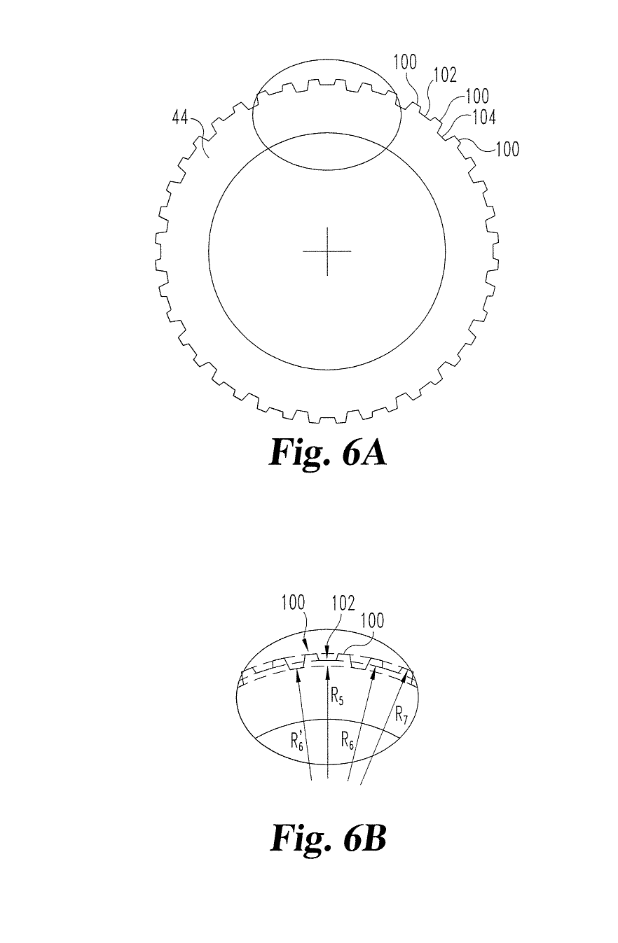

Since the bottom portion 86 is located effectively at the circle of radius R5, which defines the limit of friction material, a portion of the spaces 87 lie outside the radius R5 but are not contained within receiving portions of the housing 14. The prior art spline is illustrated in FIG. 4C and the spline of the present invention is shown in FIG. 5C. The change in spline geometry is in the depth or radius of the bottom portion 86 and consequently there is no or little need to modify the geometry of the receiving portions found in the housing or hub. As a consequence, radial clearance C′_{R} between an inner surface of the housing and the bottom portion 86 according to the current invention is significantly greater than that in spline or teeth designed according to common practice, shown as C_{R}. According to common practice, the clearance C_{R} needs only to accommodate manufacturing variations and the difference in thermal expansion in the radial direction between the plate and the receiving part of the housing FIGS. 6A and 6B illustrate another embodiment of the present invention including a plurality of splines wherein the bottom portions of adjacent teeth 102 and 104 have different radii R6 and R6′, respectively. As can be seen, the bottom portion 102 can have a radius R6 while the radii R6′ can be substantially the same as the radius R5 as seen in FIG. 5B. Consequently, the spaces defined by splines are modified such that half of them remain as those found in the prior art and the other half are configured according to the present invention. Other variations of the embodiment of FIGS. 6A and 6B include those when only some of the spaces between adjacent spline teeth 100 are modified as described such that every third or fourth bottom portion 104 has a radius R6′ while the remaining spaces include bottom portions with the radius R6. The location of the bottom portions 104, which is substantially the same as the radius R5, can be equally distributed around the outer circumference of the reaction plate or core of single sided plate or can also be irregularly distributed around the circumference thereof. The recommended radii of the modified spaces between adjacent splines are the same as in the case when all the spaces are modified. The preferred number of modified spline spaces in a plate is two or more.

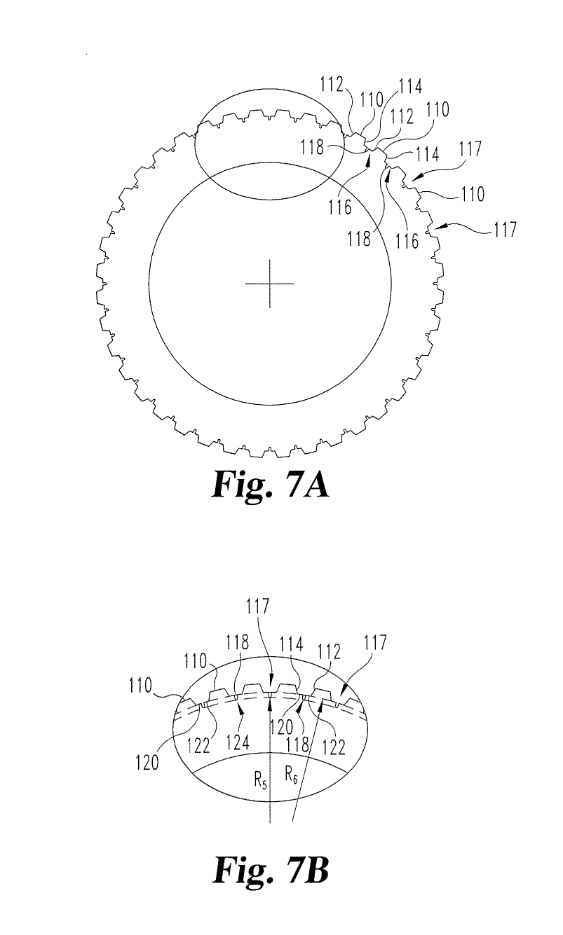

FIGS. 7A and 7B illustrate another embodiment of the present invention including a plurality of splines or teeth 110 disposed around the circumference of a reaction plate. Each of the teeth 110 includes a first side 112 and a second side 114 which are coupled together by a bottom portion 116 having a slot 118 disposed therein. Each of the teeth 110 defines a space 117 located therebetween. The bottom portion 116 includes a first section 120 coupling the second side 114 to the slot 118 and a second portion 122 coupling the slot 118 to the first side 112. A terminating portion 124 of the slot 118 extends to the outer circumference of the radii R5. The slots are made in the portions of a reaction plate that extend radially to the area defined by the friction material on the mating friction plate, such that a bottom portion 124 of the slot is substantially aligned with the radius R5. As stated above, the terminating portions 124 of radial slots 118 extend to a location substantially equal to the outer radius of the friction material R5. However, some difference is acceptable. In the case of double sided pack design it is preferred that this difference should not exceed approximately 2 millimeters or the thickness of metal reaction plate, whichever is greater; in the case of single sided pack design it is preferred that this difference should not exceed approximately 2 millimeters or the thickness of metal core of single sided plate, whichever is greater. The slot can be as narrow as practical from a manufacturing point of view. There is no minimum requirement from a stress relief aspect.

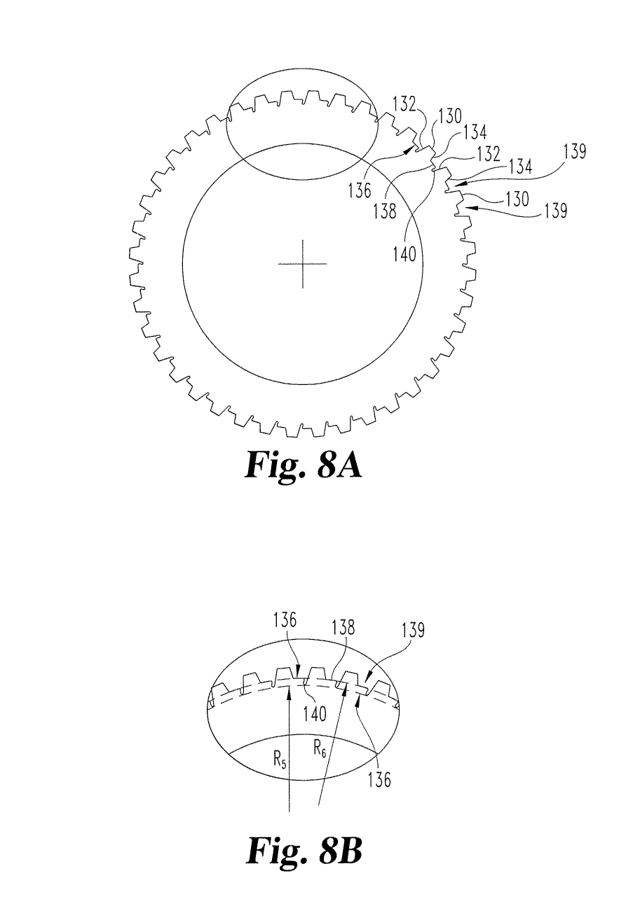

FIGS. 8A an 8B illustrate another embodiment of slots provided in a reaction plate or metal core of single sided friction plate. For instance, in the illustration of FIG. 8A, each of the plurality of splines 130 include a first side 132 and a second side 134. A bottom portion 136 includes a first portion 138 and a slot 140. Each of the splines defines a space 139 located therebetween. In this embodiment, the slot 140 includes a side portion which extends from the first side 132. It is within the scope of the present invention to extend the slot 140 from either of the sides 132 or 134 or both. Each of the slots, however, is not aligned along a radius and therefore is considered to be a non-radial slot which is distinguishable from the slots of FIGS. 7A and 7B which are aligned. As can be seen in FIG. 8B, the portion 138 extends to the radius R6 and the slot 140 extends to the radius R5. In addition, it is within the scope of the present invention for the slots to be not aligned with a side 132 or 134 but still being non-radial. The slot 140 can also include widths of different sizes.

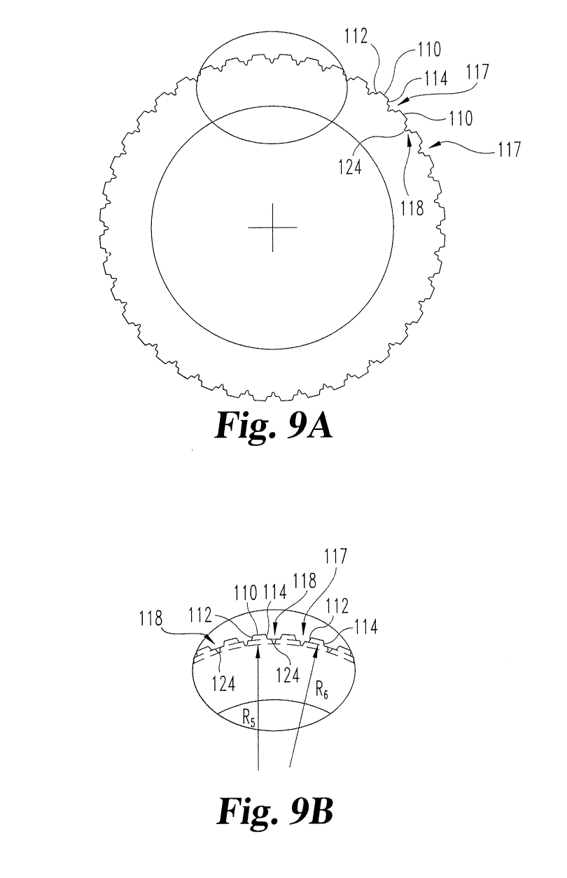

FIG. 9A and FIG. 9B illustrate another variation of the regularly aligned slots 118 of FIGS. 7A and 7B except that the edges of the slot are not parallel.

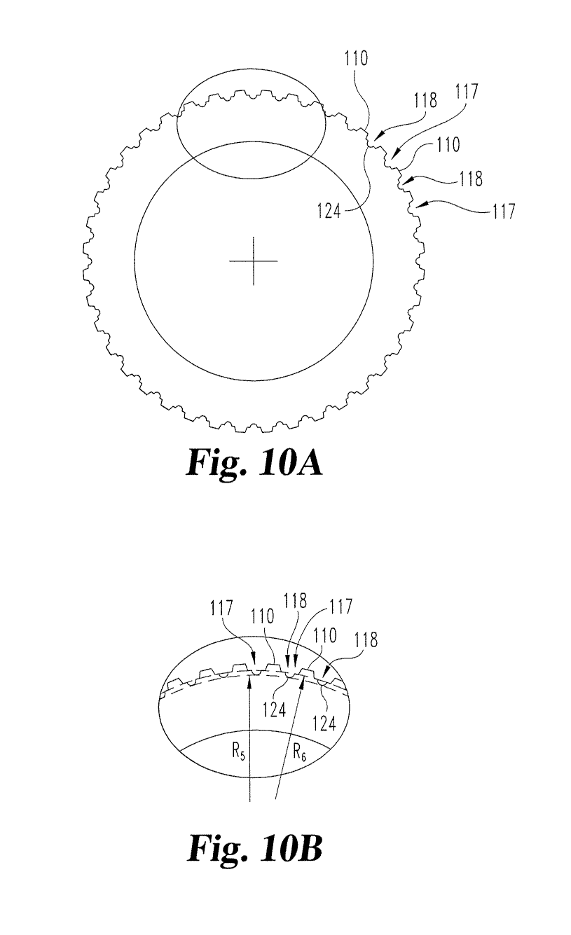

Likewise, in FIG. 10A and FIG. 10B the slot 124 is substantially circular or includes an arc.

It is preferred that each of the slots described herein includes a fillet to alleviate stress concentration caused by sharp comers which can contribute to fracture, as well as to improve the manufacturability of the slots.

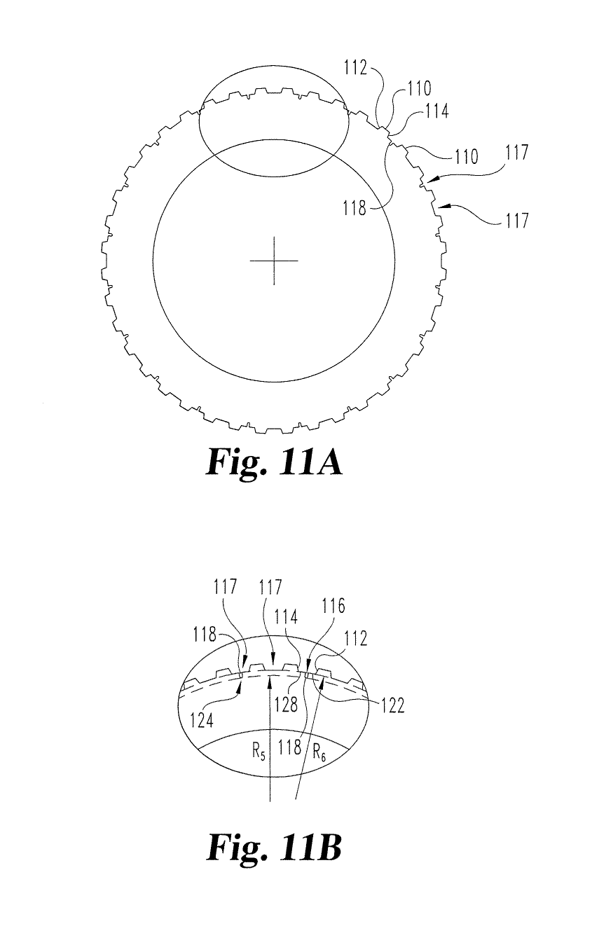

An additional embodiment of the present invention is shown in FIG. 11A where some of the bottom portions located at the spaces 117 do not include a slot. As seen in FIGS. 11A and 11B, the configuration of the slots 118 and the teeth 110 are substantially similar to the configuration of the FIGS. 7A and 7B. In FIGS. 11A and 11B, however, the slot is not located at each of the spaces 117, but instead is located at every other space 117. Other variations of the embodiment of FIGS. 11A and 11B include those when only some of the spaces between adjacent spline teeth 110 have slots. The slots can be equally distributed around the outer circumference of the reaction plate or core of a single sided plate or can be irregularly distributed around the circumference. The preferred number of slots is two or more. The recommended geometry of the slots is the same as in the case when all of the spaces have slots.

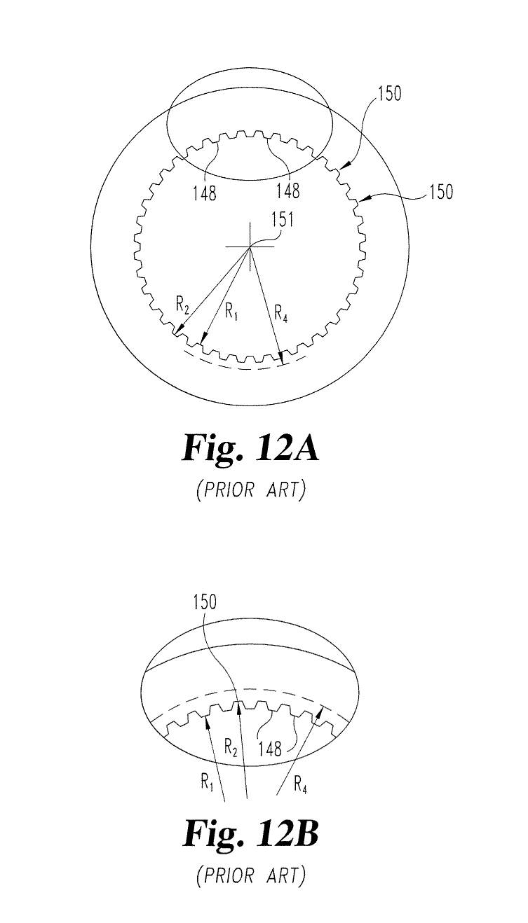

FIGS. 12A and 12B illustrate a friction plate of the prior art having inner spline 148. As can be seen, a bottom portion 150 of the space between adjacent teeth 148 does not extend into boundary between friction and non-friction area defined by the radius R4 referenced from a center 151.

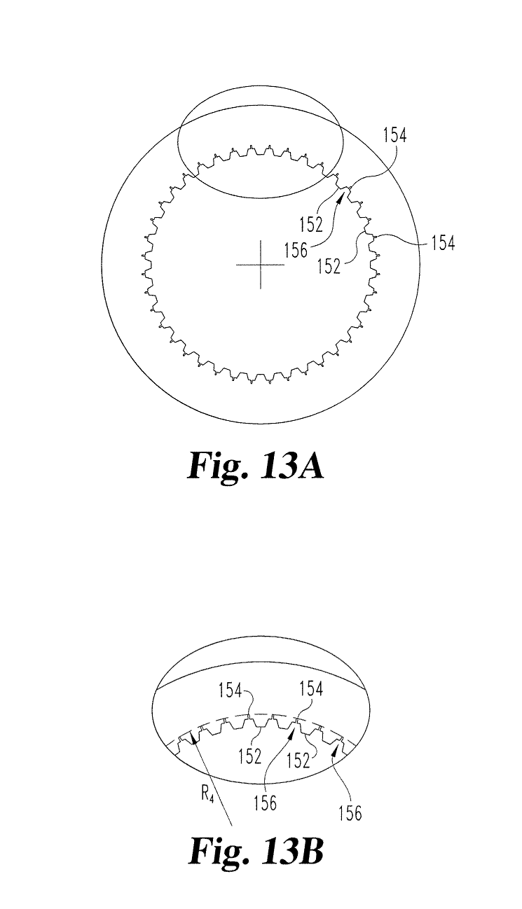

The present invention, however, as illustrated in FIGS. 13A and 13B of a reaction plate having inner splines 152, illustrates that a slot 154, located at a space 156 extends into non-friction area (the non-heated portion) but not substantially further than the friction area (heated portion) which begins at the radius R4. Consequently, it can be seen that the various configurations of splines of the present invention having spaces with or without slots as described with respect to the FIGS. 5 through 11 are equally applicable to the plates having inner splines. Furthermore, each of the embodiments described applies to both metal reaction plates in the double sided clutch pack as well as to friction plates in the single sided clutch pack. In addition, the invention applies to the end plates and apply plates in either single sided or double sided packs wherever they create a sliding interface with an adjacent friction plate.

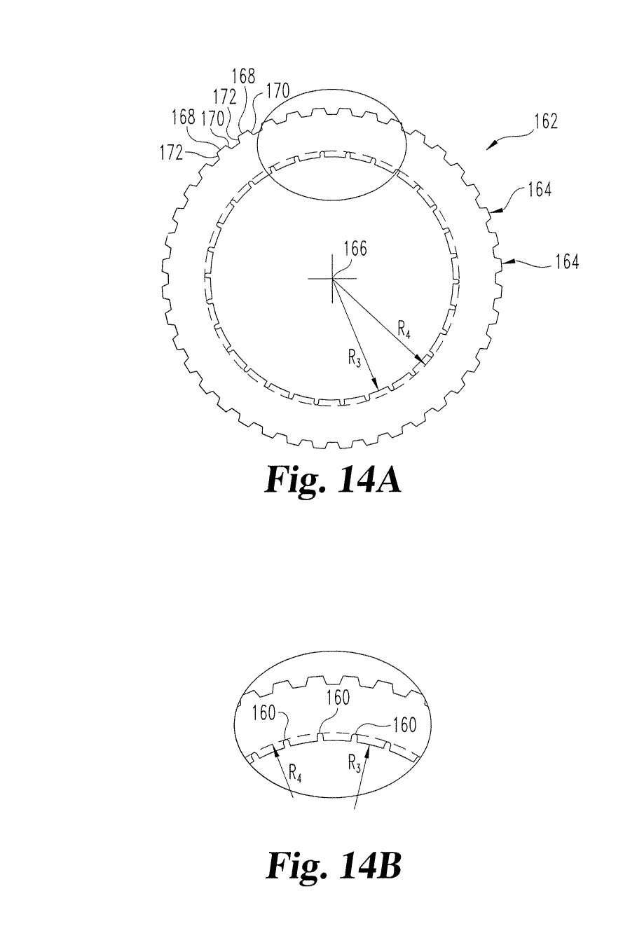

Another application of the present embodiments can include providing slots in a ring portion of a reaction plate or a single sided friction plate at a periphery without spline (opposite to that with spline). For instance, the slots can be located in the area located between the radius R3 and the radius R4 of the reaction plate 44 of the FIG. 3. In this ring of material, which is in non-friction area, and thereby not subjected to frictional heating, high circumferential stress can arise. According to the present embodiment, shown in FIGS. 14A and B, slots 160 of the same or similar type as those described for the reaction plates previously described can be provided in a plate 162. For instance, as illustrated in FIG. 14A, a plurality of splines 164 can be arranges in a circumferential pattern about a reference center 166. Each of the splines 164 includes a top portion 168, a first side 170, and a second side 172. The splines of the embodiment of FIG. 14A can be like those of the prior art as illustrated in FIG. 4A or the splines of the embodiment of FIG. 14A can be like those of the present invention including those illustrated in FIGS. 5A to 11A.

The bottom portions of the slots 160 of FIG. 14 are substantially located at the inner radius of the friction area R4 (see also FIG. 3). A number of slots can be included that are practical from a manufacturing point of view. It is preferred that the number of slots is two or more. The slots can either be equally or non-equally spaced around the inner circumference of the reaction plate or the metal core 44 of single sided friction plate. Similarly, in the case of a plate with internal splines having an outstanding ring of non-friction area at the outer periphery, the slots can be provided in that ring analogously to those described above for a ring portion located at the inner periphery.

Although the present invention includes splines for the outer periphery of the reaction plate in a double sided pack, the present invention is not limited to that described embodiment. The invention equally applies to disks with an inner or outer periphery of splines in double sided and single sided packs. According to the spirit of the present invention, the radius defining the bottoms of the slots is substantially equal to the outer boundary and/or inner boundary of the friction layer, although some differences are possible as previously described.

As used herein terms relating to properties such as geometries, shapes, sizes, and physical configurations, include properties that are substantially or about the same or equal to the properties described unless explicitly indicated to the contrary.

While the invention has been illustrated and described in detail in the drawings and foregoing description, the same is to be considered as illustrative and not restrictive in character, it being understood that preferred embodiments have been shown and described and that all changes and modifications that come within the spirit of the invention are desired to be protected. For instance, the present invention applies to plates including single sided friction plates and reaction plates. The present invention furthermore applies to apply plates and backing plates. Accordingly the present invention is intended to embrace all such alternatives, modifications, and variations that fall within the broad scope of the appended claims.

What is claimed is:

1. A torque transfer member comprising:
a plate including an annular portion having a plurality of splines, each of the plurality of splines including a bottom portion, wherein the annular portion is disposed at one of an inner or an outer perimeter of the plate, the plate defining a non-friction area and a friction area located adjacent the non-friction area and defining therebetween a boundary, wherein the bottom portion of the plurality of splines extends substantially to the boundary.

2. The torque transfer member of claim 1, wherein the bottom portion of each of the plurality of splines extends substantially to the boundary.

3. The torque transfer member of claim 1, wherein the bottom portion of some of the plurality of splines extends substantially to the boundary.

4. The torque transfer member of claim 2 wherein the bottom portion of each of the plurality of splines comprise as least one of a fillet, a chamfer, and an arc.

5. The torque transfer member of claim 2, wherein the bottom portion of each of the plurality of splines comprises a slot.

6. The torque transfer member of claim 3, wherein the bottom portions of the plurality of splines which extend to the boundary comprise a slot.

7. The torque transfer member of claim 1, wherein the plate includes a friction material coupled thereto.

8. A torque transfer member comprising:
a plate including an annular portion having a plurality of splines, each of the plurality of splines including a bottom portion having a slot, the plate defining a non-friction area and a friction area located adjacent the non-friction area and defining therebetween a boundary, wherein the slot of the bottom portion of the plurality of splines extends to the boundary.

9. The torque transfer member of claim 8, wherein the slot of the bottom portion of each of the plurality of splines extends substantially to the boundary.

10. A torque transfer apparatus comprising:
a housing;
a hub, at least partially disposed within the housing;
a first plate, coupled to one of the housing and the hub, the first plate including a friction material coupled thereto and including an annular portion having a plurality of splines, wherein the annular portion is disposed at one of an inner or an outer perimeter of the plate; and
a second plate, coupled to the other of the housing and the hub and located adjacent to the first plate, the second plate including an annular portion having a plurality of splines, wherein the annular portion is disposed at one of an inner or an outer perimeter of the plate, each of the plurality of splines including a bottom portion, the second plate defining a boundary between a non-friction area and a friction area corresponding to the location of the friction material of the first plate, the bottom portion of the plurality of splines of the second plate being located substantially at the boundary.

11. The torque transfer member of claim 10, wherein the bottom portion of each of the plurality of splines extends substantially to the boundary.

12. The torque transfer member of claim 10, wherein the wherein the bottom portion of some of the plurality of splines extends substantially to the boundary.

13. The torque transfer apparatus of claim 10, wherein the second plate includes a friction material coupled thereto.

14. The torque transfer apparatus of claim 10, wherein each of the plurality of splines of the first plate includes a bottom portion, the first plate defining a boundary between a non-friction area and a friction area corresponding to the location of the friction material of the second plate, the bottom portion of the plurality of splines of the first plate being located substantially at the boundary.

15. The torque transfer member of claim 14, wherein the bottom portion of each of the plurality of splines of the first plate extends substantially to the boundary.

16. The torque transfer member of claim 14, wherein the wherein the bottom portion of some of the plurality of splines of the first plate extends substantially to the boundary.

17. The torque transfer apparatus of claim 10, wherein the first plate includes a second friction material coupled thereto, the first mentioned friction material being located on one side of the first plate and the second friction material being located on another side of the first plate.

18. A torque transfer member comprising:
a plate including a plurality of splines, the plurality of splines being located at one of an inner and the an outer annular portion, the plate further including a plurality of slots, the slots being located at the other of the inner and the outer annular portion, wherein the plate defines a non-friction area and a friction area located adjacent the non-friction area and defining therebetween a boundary, wherein the plurality of slots extends substantially to the boundary.

19. The torque transfer member of claim 18, wherein each of the plurality of splines includes a bottom portion, the plate defining a non-friction area and a friction area located adjacent the non-friction area and defining therebetween a second boundary, wherein the bottom portion of each of the plurality of splines extends substantially to the second boundary.

20. A method of making a torque transfer plate for use in a torque transfer apparatus including a first plate and a second plate, the second plate including a friction material having a predefined area, the predefined area defining a friction area on the first plate, the method comprising the steps of:
determining the location of the friction area on the first plate and a non-friction area on the first plate relative to the friction area of the first plate;
determining a boundary on the first plate based on the determined location of the friction area and the non-friction area of the first plate; and
making the torque transfer plate to include a plurality of splines, each of the plurality of splines including a bottom portion, wherein the bottom portion of the plurality of splines is made in the non-friction area to extend to the boundary.

21. The method of claim 20, wherein the making step comprises making the bottom portion of each of the plurality of splines extends substantially to the boundary.

22. The method of claim 20, wherein the making step comprises making the bottom portion of some of the plurality of splines extends substantially to the boundary.

23. The method of claim 20, wherein the making step comprises making the bottom portion of the plurality of splines to include a slot to extend substantially no further than the boundary.
